(19) United States
(12) Patent Application Publication
(10) Pub. No.: US 2018/0260915 A1
(43) Pub. Date: Sep. 13, 2018

(54) Systems and Methods For Promoting Customer Engagement In Travel Related Programs

(71) Applicant: International Cruise & Excursion Gallery, Inc., Scottsdale, AZ (US)

(72) Inventors: John Roger Rowley, Scottsdale, AZ (US); Marcia Gene Rowley, Scottsdale, AZ (US); Tedd Floyd Davault, Clarkdale, AZ (US); Sherman Ross Crowder, Scottsdale, AZ (US)

(21) Appl. No.: 15/960,039

(22) Filed: Apr. 23, 2018

Related U.S. Application Data
(62) Division of application No. 15/783,935, filed on Oct. 13, 2017.
Application No. 15/783,935 is a continuation-in-part of application No. 14/992,520, filed on Jan. 11, 2016.
Application No. 14/992,520 is a continuation-in-part of application No. PCT/US2015/035042, filed on Jun. 10, 2015.
(60) Provisional application No. 62/089,002, filed on Dec. 8, 2014.

(51) Int. Cl. G06Q 50/12; G06Q 30/06; G06Q 30/02; G06N 5/04

(52) U.S. Cl. CPC G06Q 50/12; G06Q 30/0629; G06Q 30/0641; G06N 5/048; G06Q 30/0226

(57) ABSTRACT

Systems and methods are provided for normalizing hotel rooms across independent distribution channels. The method includes creating a meta-category matrix of sameness metrics for the hotel rooms based on a set of attributes. Room descriptions for a plurality of the hotel rooms are retrieved from a plurality of the independent distribution channels. Equivalent hotel rooms are automatically assigned to the same meta-category based on a rule set applied to the retrieved room descriptions and the set of attributes. Hotel rooms that do not correspond to one of the meta-categories are identified, and are manually assigned to a meta-category. The rule set is then revised based on the manual assignment.

### CROSS-REFERENCE TO RELATED APPLICATIONS

This application claims priority, as a Divisional Application, to: i) U.S. patent application Ser. No. 15/783,935 entitled “SYSTEMS AND METHODS FOR PROMOTING CUSTOMER ENGAGEMENT IN TRAVEL RELATED PROGRAMS,” filed Oct. 13, 2017; ii) U.S. patent application Ser. No. 14/992,520 entitled “SYSTEM AND METHOD FOR UTILIZING VIRTUAL AND REAL CURRENCIES FOR PROCESSING CRUISE AND CRUISE RELATED TRANSACTIONS,” filed Jan. 11, 2016; iii) International Application Ser. No. PCT/US2015/035042, entitled “SYSTEM AND METHOD FOR UTILIZING VIRTUAL AND REAL CURRENCIES FOR PROCESSING TRANSACTIONS,” filed Jun. 10, 2015; iv) U.S. Provisional Application Ser. No. 62/089,002, entitled “SYSTEM AND METHOD FOR PROCESSING AND OPTIMIZING TRAVELER ACCOMMODATIONS,” filed on Dec. 8, 2014, the entire disclosures of each of which are hereby incorporated herein by reference.

### TECHNICAL FIELD

The present invention relates, generally, to an on-line portal offering travel related products to club members and, in particular, to a pricing engine configured to reinvest a portion of the available margin for each transaction into the member relationship to thereby increase the lifetime value of the member.

### BACKGROUND

Presently known loyalty programs such as frequent flyer clubs, shopping clubs, credit card based purchasing incentives, and vacation clubs offer financial benefits to members in return for brand loyalty and engagement. Consumers participate in loyalty programs to accumulate redeemable benefits, and to enjoy lower prices attributable to the volume-based purchasing power of the program participants. In some loyalty programs and vacation clubs, the perception of status and affluence can be an important component of membership privileges. The value of such membership is based on the overall program benefits as well as the prestige associated with being a member of the group.

In addition, travel related web sites purport to offer consumers deep discounts on hotel rooms, merchandise, cruises, and vacations by displaying both a “retail” price and a discounted price for a plurality of similar products. However, to the extent the site's revenue model involves realizing a profit on each transaction, the discounted prices necessarily include a margin above and beyond the site's product acquisition cost. As a result, consumer loyalty remains elusive; that is, consumers typically make travel related purchasing decisions based on price without regard to brand loyalty.

Systems and methods are needed which overcome the limitations of existing incentive based travel and rewards programs.

### SUMMARY OF THE INVENTION

Various embodiments of the present invention provide systems and methods for: i) tracking a member's current lifetime value (CLV) based on monetary transactions, and tracking the member's future or forecast lifetime value (FLV) based on non-monetary transactions; ii) using one or both of the CLV and FLV to compute a member preferred rate (MPR) for a purchase transaction; iii) computing the available margin for a purchase transaction as the difference between fair market value (FMV) and total net cost, and reinvesting a portion of the available margin into the relationship with the member to arrive at an MPR; iv) computing an MPR using a yield engine which considers all or a subset of net cost, FMV, CLV, FLV, and a set of business rules; v) substituting a phantom yield group lifetime value in lieu of a computed lifetime value for a member until a lifetime value can be organically derived for that member; vi) using an integrated code base to dynamically configure a polymorphic user interface across multiple uniquely branded travel sites; vii) determining a FMV for a member selected product based on web sites likely to relied upon by a particular member based on member metrics; viii) normalizing disparate hotel rooms across independent distribution channels using meta-classifications; ix) updating hotel room meta-classifications based on mis-matched room feature sets; x) a polymorphous club engine comprising a unified code base configured to simultaneously operate a plurality of differently branded sites each implementing a yield engine having member lifetime value as an input; xi) a system for tracking current lifetime value comprising monetary transactions and future lifetime value comprising non-monetary events for a plurality of members; xii) a yield management and margin management system for algorithmically allocating a portion of the available margin for a transaction to the member relationship to drive future engagement; xiii) offering a membership upgrade and using the funds to reduce FMV to an MPR in real time; xiv) a cruise rewards program which applies available margins for non-cruise transactions to future cruises to thereby induce the member to purchase a cruise earlier in the cruise cycle; xv) using a portion of the proceeds received from a member to pay a cruise folio to reduce the FMV of future non-cruise purchases; xvi) a yield engine configured to output a MPR based on member lifetime value; and xvii) a yield engine configured to output a MPR and to use the resulting transaction to influence the member's lifetime value.

Various other embodiments, aspects, and features are described in greater detail below.

### BRIEF DESCRIPTION OF THE DRAWING FIGURES

The present invention will hereinafter be described in conjunction with the appended drawing figures, wherein like numerals denote like elements, and:

FIG. 1 is a block diagram of the system level architecture of an exemplary yield engine and associated inputs and outputs in accordance with various embodiments;

FIG. 2 is a streamlined flow diagram of the system shown in FIG. 1;

FIG. 3 is block diagram illustrating core functions driven by an exemplary rules engine in accordance with various embodiments;

FIG. 4 is a screen shot of exemplary search results depicting the market rate (FMV), savings credits, and the member preferred rate (MPR) for a plurality of hotel rooms responsive to a search request in accordance with various embodiments;

FIG. 5 is a screen shot of exemplary search results depicting the market rate (FMV) and a subscriber rate for a plurality of hotel rooms responsive to a search request in accordance with various embodiments;

FIG. 6 is a screen shot of an exemplary account summary including a savings component, a certificate component, and a vacation cash component in accordance with various embodiments;

FIG. 7 is a screen shot of a table depicting an exemplary savings credit ledger in accordance with various embodiments;

FIG. 8 is an exemplary table illustrating debits and credits influencing the current lifetime value (CLV) and the future lifetime value (FLV) for a particular member in accordance with various embodiments;

FIG. 9 is an exemplary customer timeline illustrating additional factors influencing FLV for a particular customer (member) in accordance with various embodiments;

FIG. 10 is an exemplary scorecard depicting future lifetime values (FLV) for a particular customer (member) in accordance with various embodiments;

FIG. 11 is a screen shot of a landing page for an exemplary cruise rewards program in accordance with various embodiments;

FIG. 12 is a screen shot showing exemplary search results within a cruise rewards platform depicting the best nightly rate (FMV) and earned cruise credits for a plurality of hotel rooms responsive to a search request in accordance with various embodiments; and

FIG. 13 is a screen shot showing exemplary search results within a cruise rewards platform illustrating the FMV and earned cruise credits for a plurality of products (e.g., wine) in accordance with various embodiments.

### DETAILED DESCRIPTION OF PREFERRED EXEMPLARY EMBODIMENTS

Various embodiments of the present invention relate to systems and methods for offering travel related products and services to captive consumer bases, typically rewards program members. In this context, each member may be modeled as a long term revenuable asset. In contrast to traditional travel web sites, the present system does not seek to maximize profit on each transaction. Rather, the present systems and methods seek to promote ongoing engagement with each member, to thereby maximize the lifetime value of each member. In so doing, a portion of the available margin associated with each transaction may be “re-invested” into the customer relationship. That is, short term profitably may be intentionally reduced in order to increase long term profitability.

In various embodiments, program benefits are introduced which intrinsically add value, but which on an individual transactional basis may not necessarily be profitable. Rather, the system looks at the lifetime value of a consumer (e.g., a multi-year horizon). The system maintains a data fabric including a ledger of both monetary and non-monetary events for each member, such as membership fees paid, card renewal fees, promotional emails opened (and presumably read), transactions such as purchasing a cruise or a hotel room, membership upgrades, package (bundled) products, transaction upgrades (upgrading a time share or cruise cabin). A current lifetime value (CLV) influenced by monetary transactions and a future lifetime influenced by non-monetary events are fed into a yield engine, which algorithmically allocates a portion of the available margin for each purchase transaction to the member, for example in the form of credits towards future purchases.

While perhaps counterintuitive, re-investing a portion of the available profit margin, the entire margin, or even more than the entire margin, for each transaction back into the customer relationship serves to promote continued customer engagement which, in turn, tends to increase long term profitability; this is particularly true in view of the high costs of customer acquisition.

### Determining Fair Market Values

The present invention employs various techniques to determine a market rate, retail rate, or fair market value (FMV) for different product categories. The FMV is then compared to the system's fully loaded cost to acquire the product to determine the total available margin. A yield engine is then employed to allocate a portion of the available margin back to the member in the form of a discount, credit, or other alternative currency.

By way of non-limiting example, in certain contexts the system offers members a “guaranteed” discount rate of 20% -60% the retail price (FMV) for hotel rooms. The manner in which the FMV is determined and presented to the member is an important factor in earning the member's trust, thereby promoting future engagement. In many embodiments the FMV is not necessarily the lowest price available anywhere; rather, it's a price that the system and the consumer agree is a fair representation of best market rate, in view of a number of factors.

More particularly, the system may be configured to compute an FMV value for a particular hotel room type in real time, recognizing that the FMV can change from moment to moment based on market demand and other dynamic factors. When consumer enters a date and city into a search box on a travel site, the system interrogates a number of predetermined internet sources, and runs the data through an algorithm. Part of the FMV algorithm may involve weighting some sites more heavily than other sites. One objective is to compute an objectively reasonable and verifiable FMV in order to support the system's value proposition to the member. The algorithm used to compute the hotel room FMV may be configured to prioritize first tier sites, and to ignore or give lower weight to second tier sites. In this context, first tier sites may include high traffic, high visibility sites, whereas second tier sites may include sites which the member is not likely to look to for price verification.

As discussed in greater detail below, the system may be configured to dynamically manipulate FMV values for all product categories (e.g., cruise, hotels, merchandise) as needed to support value propositions. For example, some value proposition commitments promise a predetermined savings (e.g., 30%) off FMV. In order to honor these commitments the system may occasionally filter out product options which tend to suppress FMV, and only consider those sites that support a target FMV. This is consistent with the overriding principle that the FMV must be verifiable and credible, but need not be the lowest price available anywhere on the internet.

Once a FMV is determined, the system looks to existing supplier sources to ascertain the acquisition cost for the asset. After receiving a purchase commitment from the member, the system then acquires the room from whichever feed the lowest cost showed up in, such as a hotel an aggregator (e.g., Expedia), or the like. To illustrate, an FMV=$179 and an acquisition cost=$109 represents $70 in available margin the system has to work with for this member for this room purchase. The system then used a yield engine (described more fully below) to determine a member preferred rate (MPR) which, in turn, determines how much of the $70 to share with the member based on, among other factors, that member's lifetime economic value to the system. Once the consumer commits to the proposed MPR (which is lower than FMV and typically higher than the acquisition cost), the system secures the room from the supplier and sends the consumer to “checkout.”

If the member's then-current lifetime value is low, the system may take a correspondingly higher profit; if the lifetime value is high, the system may take less profit and invest a correspondingly higher amount in reducing the FMV to the effective MPR. The yield algorithm may even suggest taking an economic loss (e.g., $20) on this particular transaction and allocate $90 to reduce the FMV to the MPR, if the algorithm determines that doing so may tend to increase the member's lifetime value by more than $20.

The system employs a more complex variation of the foregoing FMV and margin determination algorithm for use with merchandise. In contrast to the relatively stable and normalized retail price structures of hotel rooms and cruises, manufacturers deeply discount products and allow their distributors to do so in close outs, over buys, and when introducing new model numbers of the same or essentially the same product, often at significant losses. The system therefore seeks to avoid using these deeply discounted prices when computing a FMV for merchandise. Again, one goal is to provide the member with a credible retail price—but not necessarily the lowest available—to facilitate a purchase decision.

In connection with merchandise FMVs, the system periodically retrieves price quotes from one or more databases and, in addition, the system may be configured to scrape web sites in real time. To conserve bandwidth, the system may only retrieve the raw HTML code, sans graphics and other images and CSS elements.

The system may retrieve a large number (e.g., hundreds) of price quotes from different sites, and verify whether a particular retailer is still selling the product at the advertised price, and/or whether this seller is an authorized distributor. The system may assign a confidence/veracity weight to various tier sites (tier 1 may include premier brands such as Macy's, Amazon; tier 2 may include secondary brands such as K-Mart, Walmart, and Ali Baba). The system may run a weighted algorithm on the tier 1 and tier 2 sites to arrive at a FMV, perhaps centered around the mode (a cluster of reputable sites advertising the same price). The system may then show that FMV to the consumer; and to reinforce the credibility of the FMV, present a number (e.g., 3-5) of links to reputable sites which display the FMV or a price very close thereto.

In one embodiment the system may use a two tiered rating system that imposes a multiplier (weighted coefficient) based on veracity. Various product web sites may be assigned to confidence levels and are ranked within each level, where Level 1 might include Best Buy and Home Depot; Level 2 may include K-Mart and Macy's; and Level 3 may include reputable local sites, for example. Each site may be ranked differently for different products (e.g., Best buy may be ranked higher for electronics than for appliances). Those skilled in the art will appreciate that ranking product websites within particular levels for purposes of determining FMV may be initially subjective, the rankings may be subsequently adjusted based on how often consumers click on a linked site to validate the FMV, which is an indicia of member confidence in the veracity of the site.

In this context, first tier sites may also contemplate those sites in which the member is likely to have confidence due to brand loyalty, previous search or purchase history, and/or individual or group affiliated socio-economic metrics (e.g., member class, annual income). Second tier sites may include popular or otherwise statistically stable sites, but from which the member is not likely to seek price verification. As a result, the system may compute two different FMVs for the same product (e.g., merchandise, hotel room), based on different member profiles.

### Using Meta-Classifications to Enhance Hotel FMVs

Unlike products which have a UPC code, air fares identified by flight and seat numbers, and cruises identified by ship names and cabin numbers, there is no objective standard for normalizing hotel rooms. This is due in part to the fact that different hotel room wholesalers often describe the same room in different terms. With approximately 350,000 hotels worldwide, and up to ten or more room types per hotel, the task of standardizing hotel rooms for purposes of determining FMVs is complex and intrinsically unstable. Currently, the present system can correlate and obtain price points (quotes) from multiple sources for approximately 70% of hotel rooms. A strategy is needed to correlate the remaining 30% of rooms which resist standardization. The present invention employs adaptive learning of fuzzy logic techniques to recruit the remaining 30% of rooms in order to obtain a more reliable FMV for hotel rooms.

One approach to standardizing non-standardized hotel rooms is to use the popularity of searches by members of different consumer groups for hotel rooms based on destination city and room type. The most frequently searched metrics are used to manually (or semi-automatically using template tools) assign rooms to one of a plurality of unique “meta-categories” defined by combinations of attributes and amenities such as, for example, non-smoking, view class (ocean, street, garden), newspaper, gym, room size, number of beds, suite, price, kitchenette, free breakfast, in-room bar, floor level (e.g., floors 1-3, 4-10, 11-20, etc.), balcony, bed size, and so on. When a room type is encountered which does not match a then existing meta-category within a master classification matrix, the system may employ one or both of the following techniques: i) use a rule set to search within the complete published description of the room provided by the hotel (i.e., beyond the key words used by the member to search for the room) and assign the room to a category based on the extended search results; and ii) revise the master classification matrix to accommodate the combination of features which characterize the mis-matched room. Subsequent rooms having the same or similar characteristics may be assigned to the same meta-category.

In some cases, the same room (or two different rooms having the same combination of features) may be described by different hotel properties in a manner that obscures the “sameness” quality of the two rooms (or two descriptions of the same room). When a suspected match occurs, the system may confirm or refute the sameness hypothesis by comparing one or more identifying metrics of the two rooms (or two descriptions of the same room), including geolocation, address, hotel name, and/or phone number.

Alternatively, apparently disparate rooms may be correlated to the same meta-category if a threshold number (e.g., at least 6 of 20) or a predetermined subset of attributes match. Those rooms that cannot be algorithmically matched to a meta-category may be used to manually revise one or both of the extended search rule set and the meta-category matrix to thereby force a match. That is, the rule set may be augmented with additional terms (e.g., “park view”) to reconcile the short description with the more complete long description of the room; for example, if “microwave” appears in the short description and “refrigerator” appears in the long description, the matching term “kitchenette” may be added to the rule set to reconcile the two apparently disparate descriptions and identify the intrinsic sameness between the two descriptions. In this way, experiential intelligence in the form of machine learning may be incorporated into the rule set, the dynamically reconfigurable meta-category matrix, and/or the implementing algorithms.

The foregoing approach may be recursively applied to mis-matched rooms until substantially all feature combinations are accounted for within the master classification matrix. As new feature combinations are encountered, new meta-categories may be created to classify them. Identifying and quantifying the intrinsic “sameness” among rooms having divergent descriptions in this way allows the system to enhance the reliability and credibility of the resulting FMVs.

### Polymorphous Club Engine Operation

Various embodiments contemplate a “B2B2C” model in which the system establishes contractual/economic relationships with a plurality of business partners for the purpose of marketing travel related products and services to captive consumer groups (“members”). The system is configured to compensate each partner for the privilege of marketing products and services to its members. Each business partner may manifest one or more points of entry (or vectors) into the system. Thus, the system employs a club engine configured to simultaneously operate a large number of similarly functioning portals (e.g., web sites). The club engine permits flexible presentations and swappable combinations for a plurality of uniquely branded sites within a single code base.

The engine dynamically morphs branding, business rules, and virtual currencies for each member and/or member class based on user credentials. In this context, a member class refers to one of a plurality of meta categories to which members may be assigned, where each class has an associated set of rules governing labeling, displays, benefits availability, currencies that can be used, and the like for all members within that segment. The engine then loads the consumer's lifetime value and event history. Based on each member's status and history, the club engine creates a personalized rules set and configures programs, discounts, price points, virtual currencies, payment options, and the like. The club engine functions as a gateway to the various product engines, as well as an accounting umbrella.

In various embodiments the club engine employs general logic with product specific rules to determine market rates (FMVs) for each site. For example, hotel APIs may be used to interrogate hotel industry APIs, retrieve rates, and compare and mash them to compute FMVs; whereas merchandise engines may interrogate databases and scrape retail websites in real time to seek pricing information.

The polymorphic behavior of the club engine allows it to simultaneously address multiple product categories from multiple sources based on one or more rules engines, while accessing multiple data servers.

### Current and Future Lifetime Values

As discussed in greater detail below, the system employs a yield engine to compute a member preferred rate (MPR) and thus the profit (or loss) for each transaction, based on a number of variables including a member's current lifetime value (CLV) and future lifetime value (FLV), product acquisition information, and a rules engine which implements partner specific business rules.

In contrast to existing travel related sites, the present system does not seek to maximize profit on a per transaction basis. Rather, it seeks to maximize the lifetime value of each member by promoting ongoing engagement. One component of driving member engagement surrounds the notion of sharing the available margin on each transaction with the member, in a manner that incents the member to return to the site for future purchases. Another component involves using individual member preferences in combination with aggregate preference data for the group to which the member belongs to customize marketing efforts directed at the member. In order to measure the effectiveness of these approaches, the system tracks current and future lifetime value metrics for each member using a multi-variable algorithm implemented in a data fabric.

For example, each member may be assigned an initial acquisition cost as well as ongoing access costs (e.g., 30% of margin) which are paid to the system partners for the privilege of engaging their members. In this context, partners may refer to aggregators who bring large groups of captive, high end purchasers to the system.

Just as the yield engine computes the available margin and MPR for each transaction, influenced by CLV and/or FLV, each completed transaction can affect lifetime values going forward. Indeed, some transactions are benign (no profit), but can still affect (or not affect) lifetime values. For example, the system may increase future lifetime value when a member opens an email or books a flight, even though those events may be revenue neutral. As such, the yield engine plays a key role in monitoring and influencing lifetime values.

Key lifetime value metrics include: member acquisition costs; marketing costs (e.g., emails, texts, outbound calls, high impact direct mail); transaction margins; positive events such as opening an email and negative events such as not opening an email or otherwise not engaging with the system for a period of time (e.g., six months); a product return, refund, trip cancellation, or negative review; paying a subscription fee; buying a prepaid vacation package; membership renewal; revenue events such as receiving revenue from a customer or from a partner on behalf of a customer; partner revenue sharing expenses; surtaxes; agent sales commissions; product cost; number of transactions, and the like.

In some circumstances members can use accumulated credits to pay some portion of their transactions. For example, paying a $1,000 annual maintenance fee for a time share may result in 1,000 credits in the member's account. The member can use some portion of it to reduce the out of pocket cost of a transaction from FMV to MPR. In this way the member is incented to engage in future transactions, thereby increasing the member's future lifetime value.

The foregoing lifetime value metrics and the manner in which they are collected and maintained are discussed in greater detail.

### Overall System Operation

The system seeks to optimize long term revenue for each member through the use of yield management and margin management techniques. In this regard, predictive analytics may be applied to the member's engagement activities to induce the member to upgrade or take other actions to increase lifetime value. Lifetime value information is fed back into the system and used to: i) affect future transactions (e.g., influence future MPR values); and ii) fine tune targeted sales pitches to the member. For example, if the system determines that a member desires a European cruise, the system will avoid pitching a Mexican Riviera cruise. Relevant member preferences may be derived or inferred from emails opened and not opened by the member; a member's search and navigation activities; measured group behavior metrics (tracking customer segmentation, socio-demographic learning and modeling); purchases of rooms form large hotel chains vs independent boutiques; and tendency to open discounted travel offers, while ignoring destination oriented offers. The system may use machine learning to identify, characterize, and weight these and other factors and apply the machine learning to fine tune customized marketing pitches.

By employing member appropriate (relevant to this particular member's preferences) messaging, future engagement and future lifetime value are correspondingly advanced.

For a member selected product, the system determines the fully loaded cost of the product and the retail value (FMV) and, hence, the total available margin. The yield engine algorithmically calculates a member preferred price/value (MPR) which generally corresponds to the amount charged to the member's credit card for the transaction. In a typical use case, the system invites the member to apply membership currency (described below) to reduce the displayed FMV to the displayed MPR, and displays a notice indicating that savings credit has been applied to arrive at “your price” for this transaction.

Existing hotel sites display a market rate and discount rate for a plurality of rooms. However, the discount rate typically seeks to maximize profit for each transaction. In accordance with the present invention, the yield engine applies membership currency to further reduce the discount rate down to the MPR, which is usually less than other sites' discount rate because those sites seek to maximize margin on the transaction—whereas in the present invention some of the available margin is re-invested into the member relationship to promote FLV. In an alternate embodiment, if this member does not have sufficient membership currency to reduce the FMV to an attractive MPR, the system displays a notice indicating how much “currency” (and the resulting MPR) the member would enjoy by purchasing an upgrade right now.

In yet a further embodiment, the system may use statistical data regarding the effect of pricing on other members' FLVs when determining an MPR for a particular member.

### Alternative Currencies

In an embodiment, the system contemplates at least three different types of alternative “currencies”: certificates; burn currency; and earn currency. More particularly, a member may log into a member portal and navigate to a “my account” page which summarizes the member's available currencies (primarily based on previous transactions), including savings credits (burn currency), redeemable certificates, and vacation cash a/k/a “my cash” (earn currency). Some algorithmically-determined (by the yield engine) portion of the savings credit can be used to reduce the FMV price to the MPR price. The savings credit (burn currency) is typically funded with memberships, upgrades, renewals, promotions, and the like. Each membership account includes a detailed savings credit ledger, listing the debits and credits applied to the account. The savings credits do not match the debits/credits dollar for dollar; that is, a $100 subscription renewal may result in a $150 credit.

On the other hand, vacation currency (earn currency) is considered to be a margin funded currency, funded through previously paid FMV transactions where the difference between FMV and MPR is stored as future earn currency.

Certificates are typically used by a member to obtain a baseline product, such as a “free” seven day cruise for two people. Often a member will elect to pay additional money to upgrade at the time of redemption, for example from an inner to an outer cabin. As such, the system may be configured to factor the average additional yield (attributable to the upgrade) into the base certificate “buying power.” Cruise lines are willing to provide certificates at deeply discounted rates because members tend to spend more on food, alcohol and entertainment (e.g., gambling) than customers who pay retail.

### Cruise Rewards (aka Ocean Rewards)

Although many cruise lines have recognition programs, they typically are not true cruise rewards programs. This is in part attributable to the fact that the average cruiser purchases a cruise every 3.5 years. Moreover, cruise lines are not well equipped to compete with travel sites to offer hotels, merchandise, and non-cruise related vacation packages. Cruise lines therefore have difficulty maintaining engagement with their customers between cruises. The present invention offers a meaningful cruise rewards program, which leverages the fact that consumers who cruise also tend to spend money on: restaurants; resorts; hotels; everyday items; tours; on-line shopping; and wine. By incenting members with margin dollars stored as vacation credits, the time between cruises can be accelerated. Moreover, by maintaining ongoing contact with the cruise program member, their next cruise will more likely be selected from the cruise supplier's inventory. This may be facilitated by using the margins associated with normal purchasing behavior to motivate members to purchase a cruise earlier in their regular cruise cycle.

Specifically, once a new cruise rewards program member registers with a portal, subsequent purchases at hotels, restaurants, tours, and other non-cruise purchases made through the portal result in available margins, a portion of which may be stored in a savings account to be applied to the member's next cruise.

In one embodiment, the margin dollars resulting from non-cruise purchases may be used to fund a stored value credit card, which can be used dollar for dollar on the cruise ship, or to pay for the cruise itself. The system employs the aforementioned FMV algorithms and yield engine (described in detail below) to determine the available margins for non-cruise purchases, thereby providing real margin dollars (which are paid by the consumer at each transaction) to defray the net out of pocket cost for the next cruise, while respecting the cruise line's retail price points.

To underscore the benefits associated with non-cruise related purchases, the system shows cash going into the savings account in real time. For example, instead of indicating that “you saved $200 on this hotel stay,” the system displays a notice to the effect that “we added another $200 to your cruise savings account.”

All transactions on the cruise rewards program site may earn points towards the next cruise, or may be used to pay for merchandise, rental cars, wine, golf, airfare, so long as the purchase is transacted using the cruise rewards program site. For example, a member can pay a $30 FMV price for a bottle of wine, and store some portion of the available margin (e.g., 14 points) for later use. One of the keys to this type of “earn” model is that instead of applying a portion of the available margin to reduce FMV to MPR as discussed above, the available margin dollars are stored as earned points (e.g., Vacation Cash) on the site for future use. That is, the member actually pays FMV or close to it, and the “savings” are stored as points or credits. Alternatively, the system can apply the savings account to the member's on board spend bill (the folio) at the end of the cruise (as opposed to applying it to the cost of the cruise itself).

Significantly, the earned vacation cash is considered funded which means that the member can use it to reduce the out of pocket cost for non-cruise purchases even lower than MPR; indeed, the earned points can be used to reduce the FMV all the way down to taxes and fees. Of course that presumes that the member's available vacation cash exceeds the total available margin for the transaction.

In an alternative embodiment of a cruise rewards program, instead of earning margin dollars in advance, the member can pay the full retail price (e.g., FMV) for the cruise. When the member pays their folio account at the end of the cruise, the system funds an amount equal to or in the range of the folio into a savings account which can then be used to pay down some of the margins for future purchases of hotels, meals, wine, and merchandise using the portal; that is, the member can reduce the price from FMV down to somewhere near the wholesale cost, funded by the previously paid folio. This motivates the consumer to upsell on subsequent purchases, because the member can use previously allocated credits to pay some of the incremental cost of future transactions.

### Business Rules

As used herein, the term Business Rules broadly contemplates any number of program or partner idiosyncrasies and nuances. By way of non-limiting illustrative example, a particular partner portal may prefer that the system not sell hotel rooms offered by that partner to members who own time shares at one of that partner's properties, because it may tend to undersell their own program. Other rules require a 14 day advance purchase, and do not permit same day bookings. Other rules may require pricing to be displayed as total stay, nightly stay, tax inclusive/exclusive, or that no king size beds be made available to smokers. Vacation Club partners may want to offer hotels to its members, but not offer competitor hotels to its members. So the takeaway is that the system has to know various metrics about the member (e.g., married/single, property owner, income level, citizenship), and superimpose those business rules with member metrics. Moreover, business rules are based on inferences and preferences learned over time, and are thus subject to change over time.

### Yield Engine Architecture

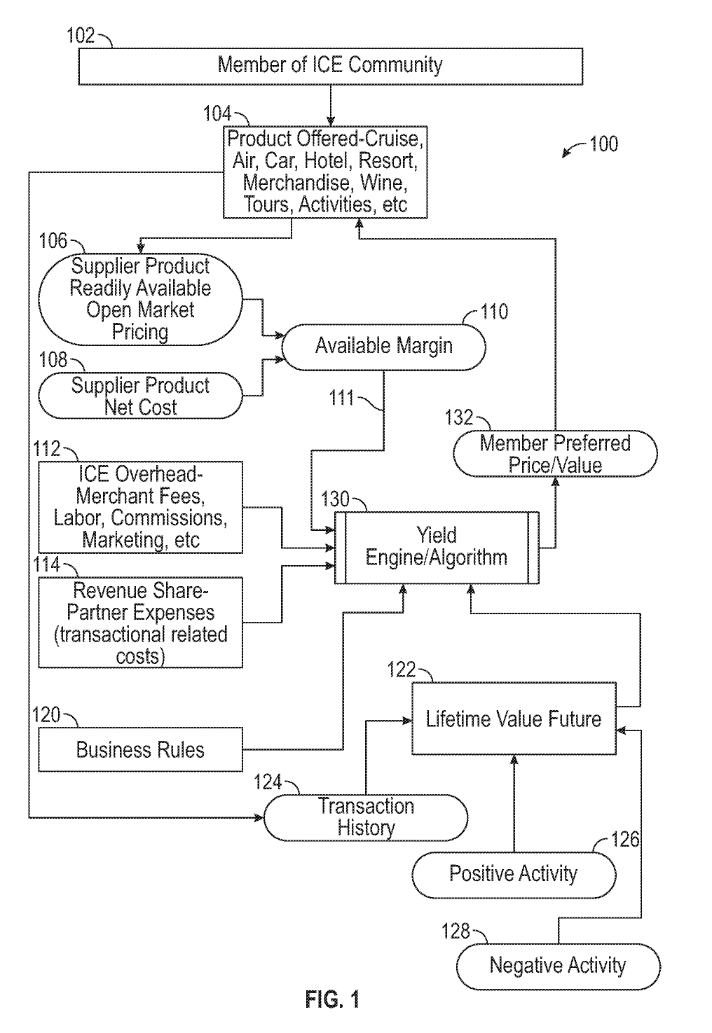

Referring now to FIG. 1, an exemplary yield engine system level architecture 100 includes a member portal 102, a search and product selection module 104, a fair market value (FMV) module 106, a product acquisition cost module 108, and an available margin module 110. The system 100 further includes an overhead cost module 112, a transactional cost module 114, a business rules module 120, a transaction history module 124, a positive activity module 126, a negative activity module 128, and a current and future lifetime value module 122. The foregoing inputs are applied to a yield engine 130, which executes one or more algorithms to output a member preferred price/value 132.

More particularly, the member portal 102 may be any one of a number of member entry vectors, including web sites implemented on a handheld mobile device such as a smartphone, laptop computer, or the like. Upon accessing a travel site operated by the aforementioned club engine (or a stand-alone platform), the member may navigate through various categories and select a desired cruise, airline, train, bus, marine, or other mode of transportation, rental car, resort, time share, merchandise, vacation, wine, clothing, concert, sports, or other entertainment event, tour, or other activity, product, service, or transaction. In a preferred embodiment, the member must first register with the site in order to be eligible to access its features, as the site is typically only available to members and not otherwise available to the general public.

Once the member selects a desired product or service, the FMV module 106 determines a FMV for the product, and optionally displays one or more links to other sites to allow the member to verify the credibility and veracity of the FMV. The product acquisition cost module 108 computes the net cost to the system to acquire the product, for example by interrogating a plurality of sources to retrieve the best wholesale price available at the current time for the selected product in the context of existing supplier relationships. In an embodiment, the system dynamically calls out to vendors (suppliers) with whom the system has negotiated pricing schedules. In this regard, supplier costs for the same product can vary significantly due to market dynamics. For example, a product (e.g., room, flight) purchased on September 1 for travel October 1 may reflect a different cost than the same October 1 travel product purchased on September 2; similarly, a product purchased on September 1 for travel October 1 may reflect a different cost than the same product purchased on September 1.

Based on the FMV and the net cost, the available margin module determines a gross margin 111 for the product. It remains to determine what portion of the available margin should optimally be allocated as system profit, and what portion should optimally be re-invested into the relationship with the member to induce future engagement and, ultimately, maximize the future lifetime value of the member. Various embodiments also contemplate re-investing an amount equal to or even greater than the available margin into the member relationship to further subsidize the transaction, if warranted by a lifetime value analysis, for example if the member has a cruise certificate or credits which will likely result in a future upgrade upon redemption.

Before or concurrently with calculating a member preferred rate (MPR) for the transaction, the system determines the fully loaded cost of the product considering both hard and soft overhead costs. In particular, the overhead cost module 112 accounts for operating expenses including merchant fees (e.g., credit card processing fees), labor, commissions, insurance, regulatory, administrative, and marketing costs, and the like. The transactional cost module 114 accounts for partner expenses such as revenue sharing arrangements and other transaction related costs and fees. The expenses associated with modules 112 and 114 are deducted from the gross margin 111 to yield a net available margin, but the outputs of modules 112, 114 are shown separately applied to the yield calculator 13 inasmuch as they may be a function of the MPR value (e.g., a 3% processing fee).

Although preferred embodiments may be discussed in terms of a single FMV and a single MPR to enhance clarity, those skilled in the art will appreciate that typical use cases involve determining separate (though not necessarily unique) FMV and MPR values and associated gross and net margins for a plurality of products responsive to a member search request.

With continued reference to FIG. 1, the business rules engine 120 applies appropriate business rules to the yield engine and, as discussed below, may even supersede the MPR output by the yield engine. Finally, one or both of the member's current and future lifetime values 122 are applied to the yield engine, where the lifetime values are informed by the member's monetary transaction history 124 and non-monetary event history 126, 128. Although not illustrated in FIG. 1, it will be appreciated that once the transaction is completed (or otherwise terminated), information regarding the transaction may be reflected in the member's current and/or future lifetime value determinations.

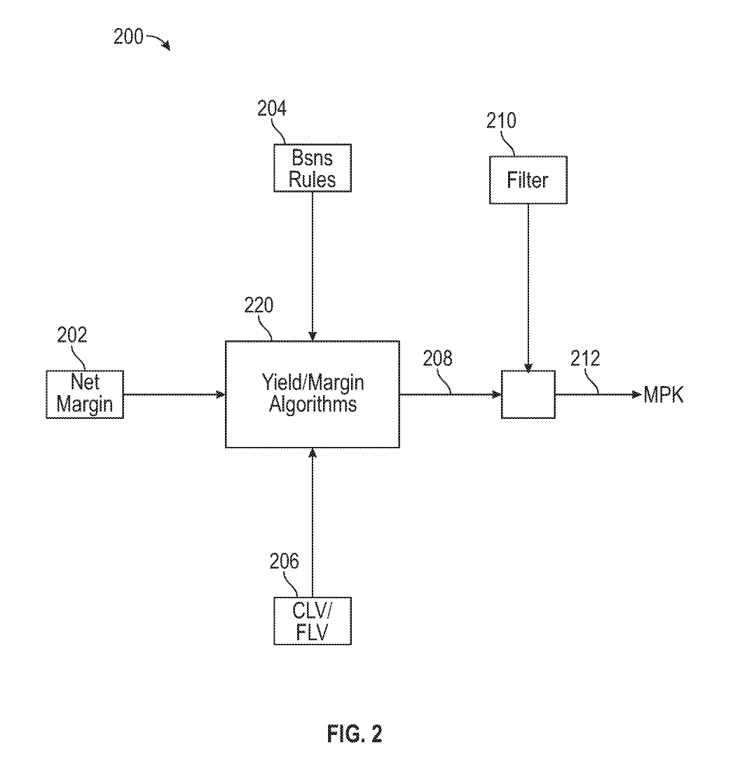

In particular and with momentary reference to FIG. 2, a streamlined flow architecture 200 depicts a net available margin module 202, a rules engine 204, and a lifetime value module 206 applying corresponding signals to a yield/margin calculator 220 configured to output a plurality of search results 208 which, in turn, are filtered and prioritized by a filter module 210 to produce one or more MPR values 212 corresponding to one or more product options available for final selection by the member. It will be appreciated that the member's alternative currencies which may available to reduce the FMV to the MPR are embodied in the CLV and FLV parameters, as implemented by the business rules.

Accordingly, an exemplary equation for determining an MPR value (or other quantity output by the yield engine) may be expressed as a function of MPR, TC (total product cost), and LV (one or both of FLV and CLV):

MPR=ƒ[FMV, TC, LV]; or, more particularly

MPR=TC−FMV+Q;

where Q is a weighted, single or multi-variable expression which contemplates various monetary and/or non-monetary events which together comprise the quantity LV.

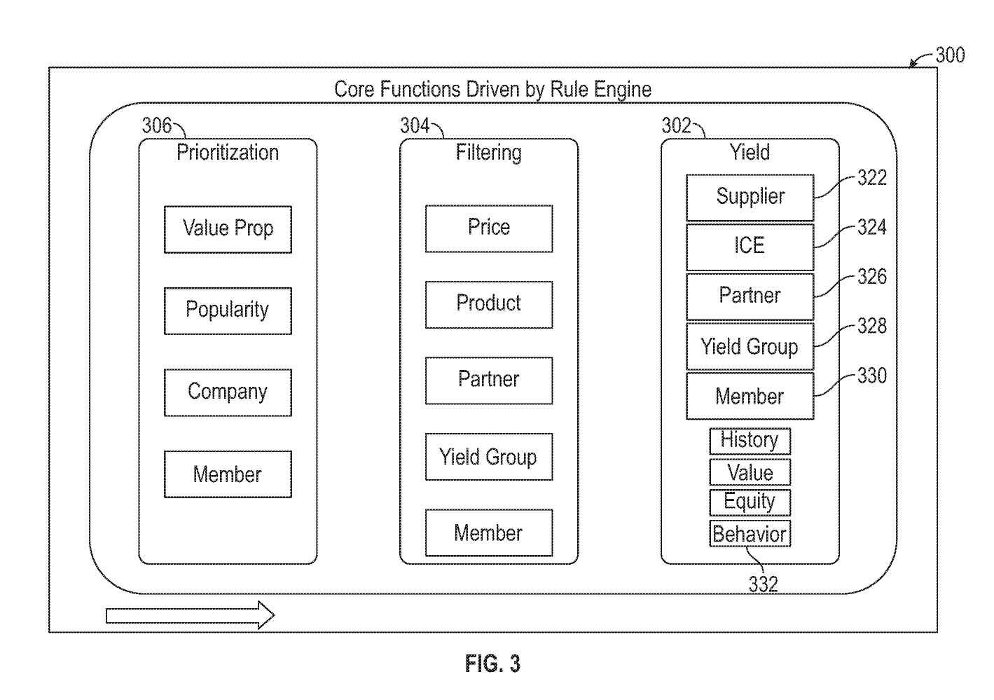

FIG. 3 illustrates various functions 300 implemented by an exemplary rules engine, and includes a yield module 302, a filter module 304, and a prioritization module 306. More particularly, the foregoing description of the yield engine and its various inputs generally corresponds to the yield module 302, wherein the supplier parameter 322 relates to the net supplier costs; the ICE parameter 324 relates to the overhead costs including merchant fees; the partner parameter 326 relates to the transactional costs including revenue sharing and partner expenses; the yield group parameter 328 relates to the system's ability to use information for the member's demographic group until it develops a profile for this particular member; member parameter 330 relates to lifetime value factors 332 including CLV metrics (transaction history, value, and equity) and FLV metrics (behavior such as opening emails and responding to marketing pitches).

With continued reference to FIG. 3, the filtering module 304 and the prioritization module 306 implement the business rules. The filtering module may determine, inter alia, what products and prices or price ranges the system is allowed to display for a particular partner; that is, a partner may have defined minimum or maximum values, or defined certain product sources that are particularly compatible or incompatible with the partner's preferences for its members.

The Yield Group function allows the system to substitute the member's demographic group profile until it learns enough information about this particular member. For example, use a profile associated with the group that the member originated from, or the system may assign the member to a temporary yield group based on some combination of where the member lives, or some combination of factors including the member's age, marital status, and/or estimated income based on tracked purchases. That is, the system may use a suitable stable profile until a member specific profile can be organically derived.

The Member function considers various member classes, such as Government employee, particular program affiliations, and at a more macro level allows the system to kick in and override a particular MPR, if appropriate. Alternatively, the system can determine an MPR based on a yield group, and then make a decision to adjust it based on factors including this member's CLV and/or FLV.

For example, if a cruise is sold to a new member based on yield group metrics as opposed to that member's individual purchase history (because it does not yet exist), the system may provide further discounts or incentives to account for the fact that the member is still within a rescission period.

The prioritization module refers to the order in which the search results are displayed, considering such factors as geo-targeting, as well as group and individual member demographics and metrics. The company parameter suggests that properties owned or controlled by a particular brand should be listed first.

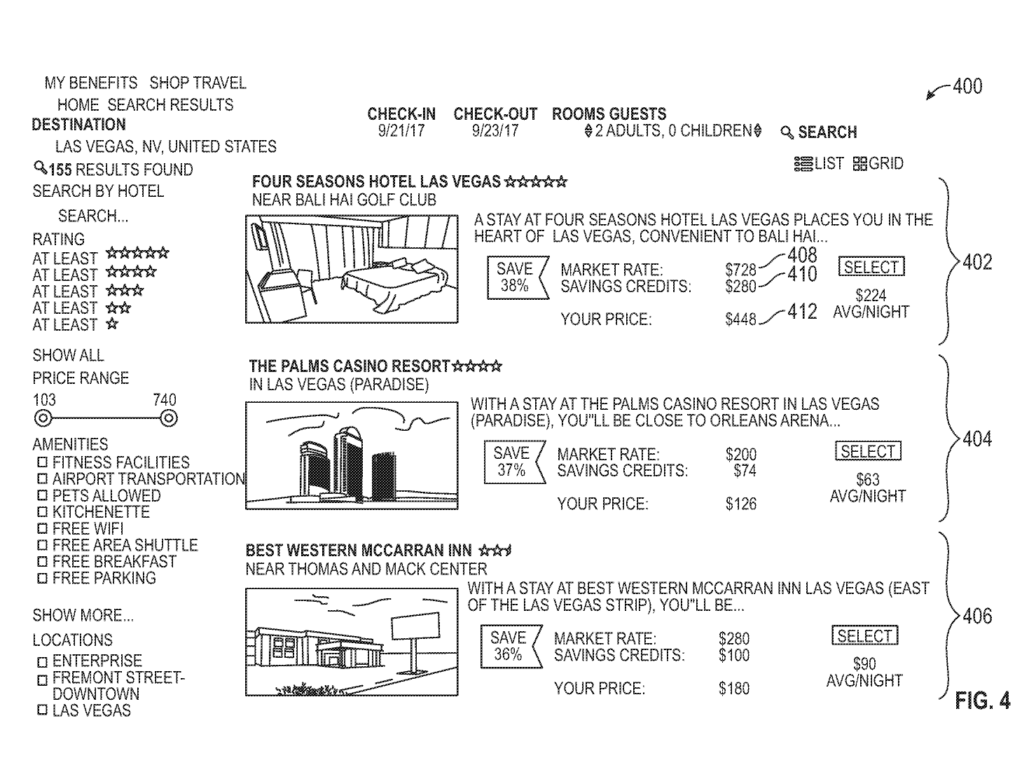

FIG. 4 is a screen shot 400 illustrating exemplary search results including available hotel room profiles 402, 404, and 406, each depicting a market rate (FMV) 408, putatively applied savings credits 410, and a resulting member preferred rate (MPR) 412.

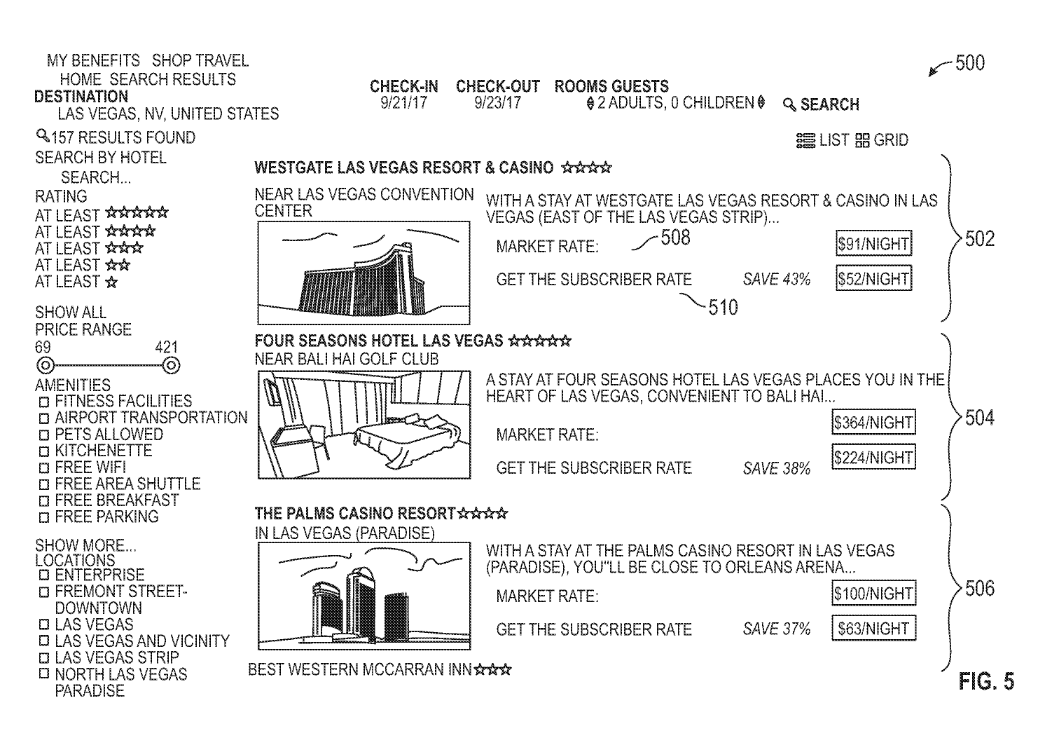

In contrast to FIG. 4, FIG. 5 is a screen shot 500 illustrating exemplary search results including available hotel room profiles 502, 504, and 506, each depicting a market rate (FMV) 508 and a proposed subscriber rate 510 to which the member would be entitled if the member were to purchase a membership upgrade as part of the current transaction.

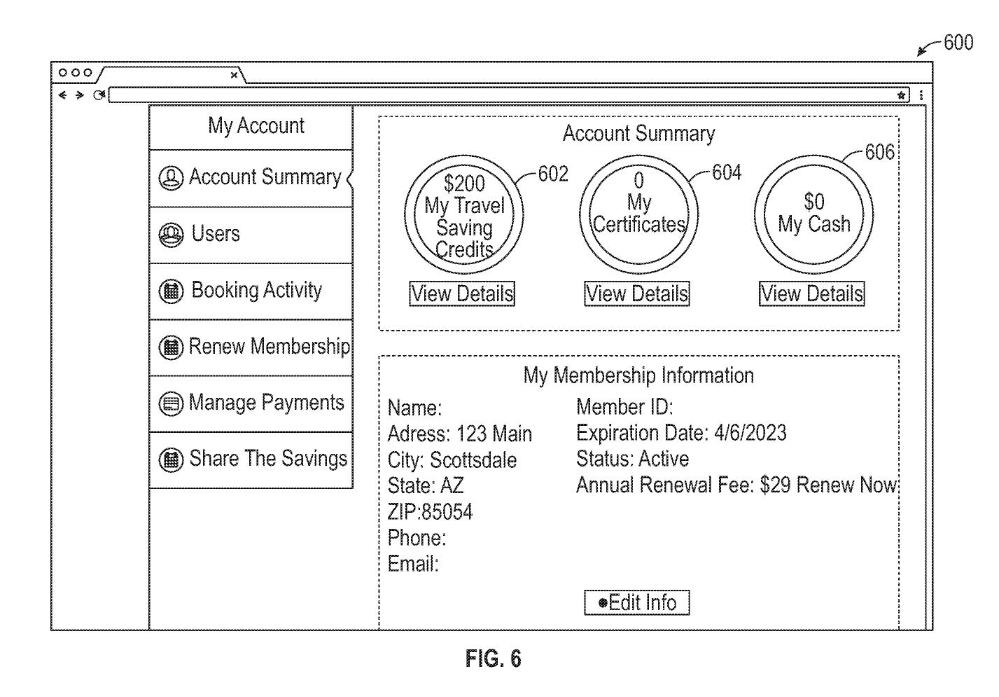

FIG. 6 is a screen shot of an exemplary account summary page 60o illustrating various alternative currencies including a savings component 602, a certificate component 604, and a vacation cash component 606.

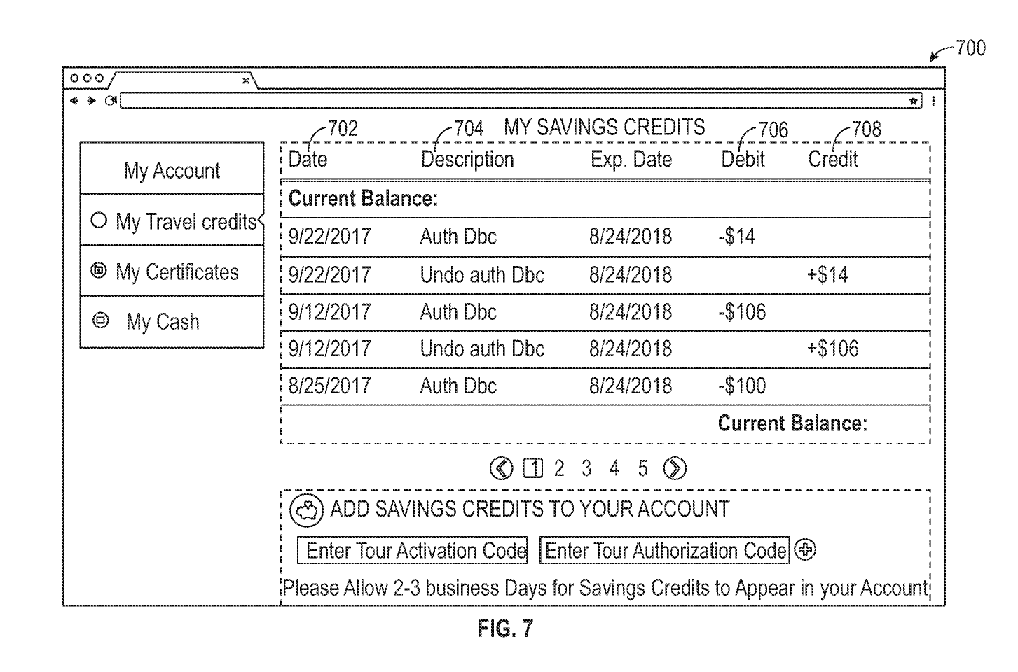

FIG. 7 is a screen shot of an exemplary table 700 representing a savings credit ledger including a transaction date column 702, a description column 704, a debit column 706, and a credit column 708. The savings credit summary is generally analogous to the current lifetime value of a member in that it tracks monetary events. The savings credit balance can be used to reduce the FMV down to the MPR for a transaction, subject to limitations imposed by the business rules. For example, in some embodiments the business rules limit the amount of savings credit (also referred to as “earn” credits) that can be used on a particular transaction inasmuch as the savings credits are regarded as margin funded credits. In contrast, the “my cash” or vacation cash (see item 606 in FIG. 6) component is regarded as the equivalent of cash since it is typically funded directly by the member. As such, the vacation cash may generally be used to buy down the FMV even below the MPR.

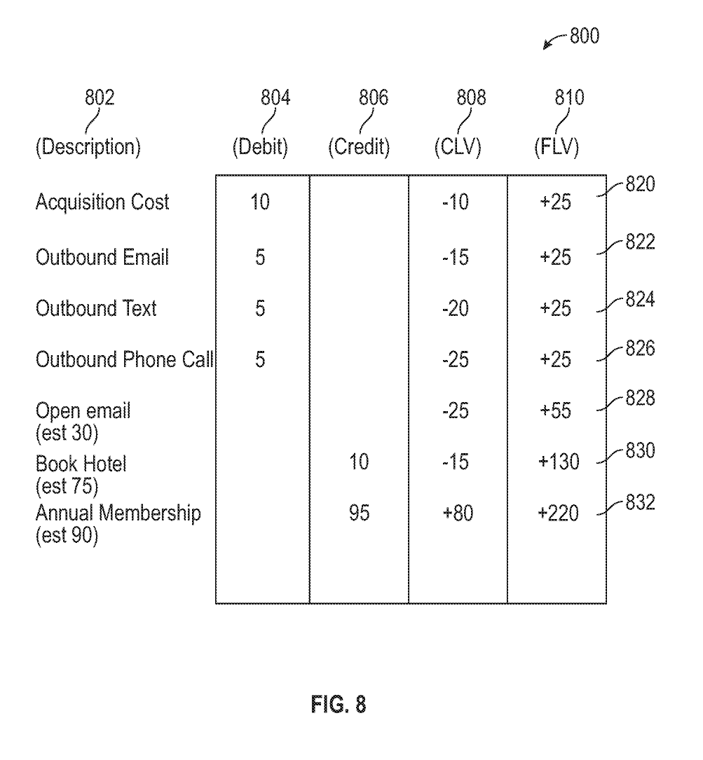

FIG. 8 is an exemplary running ledger illustrating debits and credits associated with the current lifetime value (CLV) and the future lifetime value (FLV) for a particular member. More particularly, the table 800 includes a description column 802, a debit column 804, a credit column 806, a current lifetime value (CLV) column 808, and a future or forecast lifetime value (FLV) column 810.

A first entry 82o involves the acquisition cost for the member, estimated to be $10 based, for example, on the aggregate cost of acquiring the group divided by the number of group members. Based on the monetary value of the acquisition cost, a corresponding $10 debit is entered into the debit column resulting in a −$10 CLV. However, the system values the opportunity for future revenue resulting from the acquisition of this member at $25 and, accordingly, an initial FLV of $25 is assigned to this member. Based on this member's future purchasing patterns, as well as the purchasing patterns of other members of this same group, the initial FLV assigned to subsequent members from this same group may be adjusted upwardly or downwardly, as appropriate to reflect actual experiential values.

A second entry 822 relates to a marketing email sent by the system to the member. Based on the cost associated with preparing and sending the email, a corresponding $5 debit is entered into the debit column, further reducing the CLV to −$15 (−10−5=−20). The system determined that the sending of the email does not affect this member's FLV, which remains at $25.

A third entry 824 relates to a marketing text sent by the system to the member. Based on the cost associated with preparing and sending the text, a corresponding $5 debit is entered into the debit column, further reducing the CLV to −$20 (−15−5=−20). The system determined that the sending of the text does not impact this member's FLV, which remains at $25.

A fourth entry 826 relates to an outbound phone call placed by the system to the member. Based on the cost associated with placing the call, a corresponding $5 debit is entered into the debit column, further reducing the CLV to −$25 (−20−5=−25). The system determined that the sending of the text does not impact this member's FLV, which remains at $25.

A fifth entry 828 relates to the member opening an email (or text) previously received from the system. Since opening the email does not involve a credit or debit, the member's CLV remains at $25. However, the system values the opportunity for additional future revenue resulting from the member opening the email at $30 and, accordingly, $30 is added to the FLV column resulting in a new current FLV of S55 (25+30 =55).

With continued reference to FIG. 8, a sixth entry 830 relates to the member purchasing a hotel room resulting in a $10 net profit flowing to the system. Accordingly, $10 is added to the credit column resulting in a new CLV of −$15 (−25+10=−15). In addition, the system determined that the opportunity for additional future revenue resulting from this booking is valued at S75 and, accordingly, $75 is added to the FLV column resulting in a new current FLV of $130 (55+75=130).

A seventh entry 832 relates to the member purchasing or renewing a membership resulting in a $95 net profit flowing to the system. Accordingly, $95 is added to the credit column resulting in a new CLV of $80 (−15+95=80). In addition, the system valued that the opportunity for additional future revenue resulting from this payment at $90 and, accordingly, $90 is added to the FLV column resulting in a new current FLV of $220 (130+90 =220).

It will be appreciated that the foregoing description of entries 820−832 are illustrative, and that any number of events and associated values could be employed to illustrate the manner in which monetary and non-monetary events impact CLV and FLV valuations. Accordingly, an exemplary equation for determining a lifetime value (LV), whether current, future, or a hybrid involving both quantities, may be expressed as:

LV=Ax+By . . . +Cz;

where A, B, and C represent weighted coefficients having a zero or non-zero value; and x, y, . . . z represent point or currency values associated with monetary and/or non-monetary events.

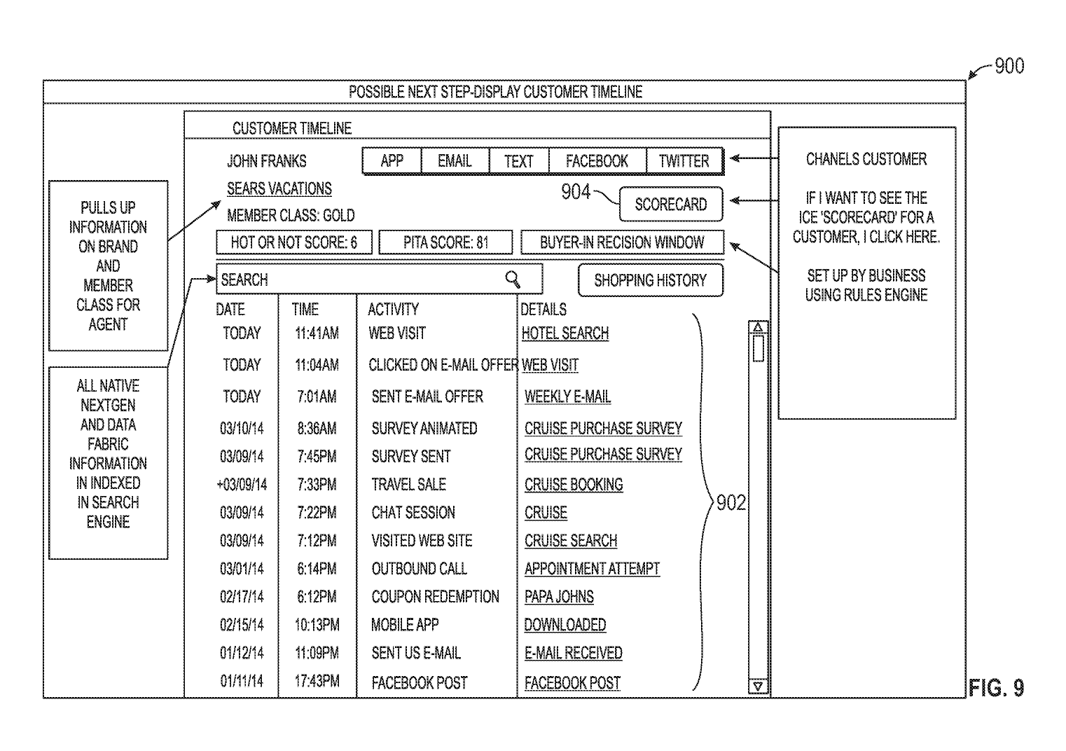

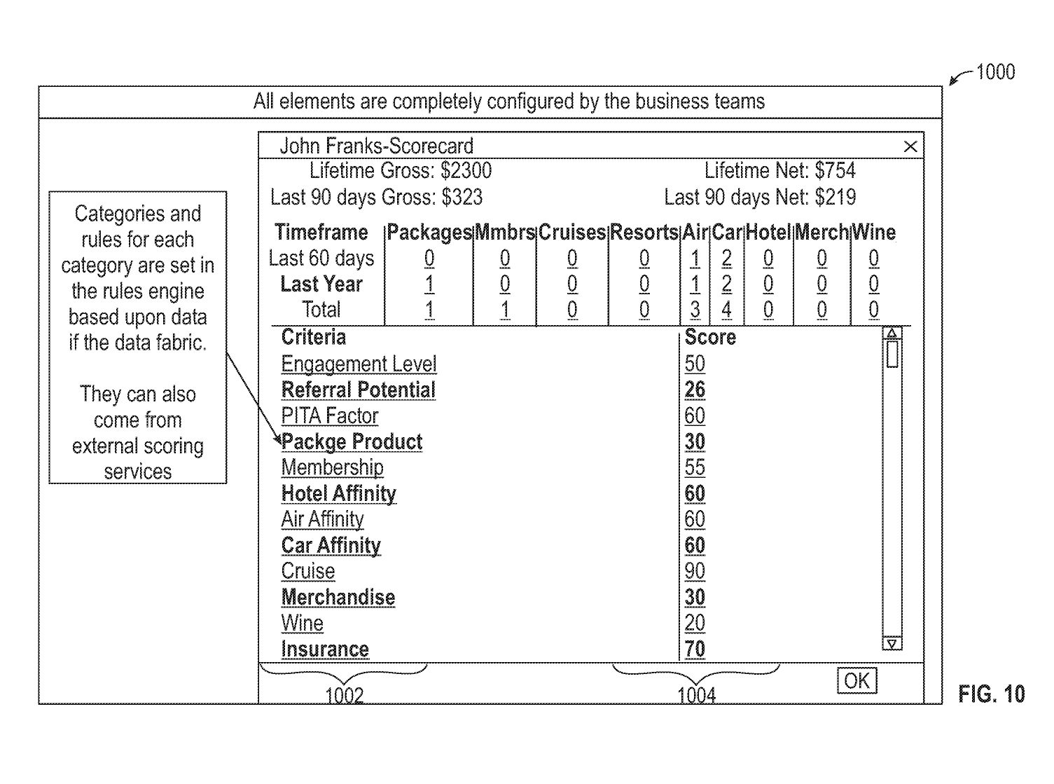

FIG. 9 is an exemplary customer timeline 900 illustrating both monetary and non-monetary factors 902 which can be used by the system to influence the CLV and FLV values for a particular member. In particular, the factors 902 may include: search activity, browsing activity, opening emails, not opening emails, purchase transactions, responding to surveys, participating in community discussions, redeeming sponsored coupons, communicating or otherwise engaging with the system. In an embodiment, the customer timeline is available to system sales and marketing personnel. Clicking the scorecard icon 904 reveals the member's scorecard, shown in FIG. 10.

Referring now to FIG. 10, an exemplary scorecard 1000 depicts various scoring criteria 1002 and corresponding values 1004 assigned by the system. These values may be algorithmically weighted and used to quantify the member's FLV. The criteria may include factors relating to the member's affinity for various product categories, such as cruise, hotel, air, as well as additional factors which seek to quantify non-monetary member attributes which tend to predict the member's future purchasing potential.

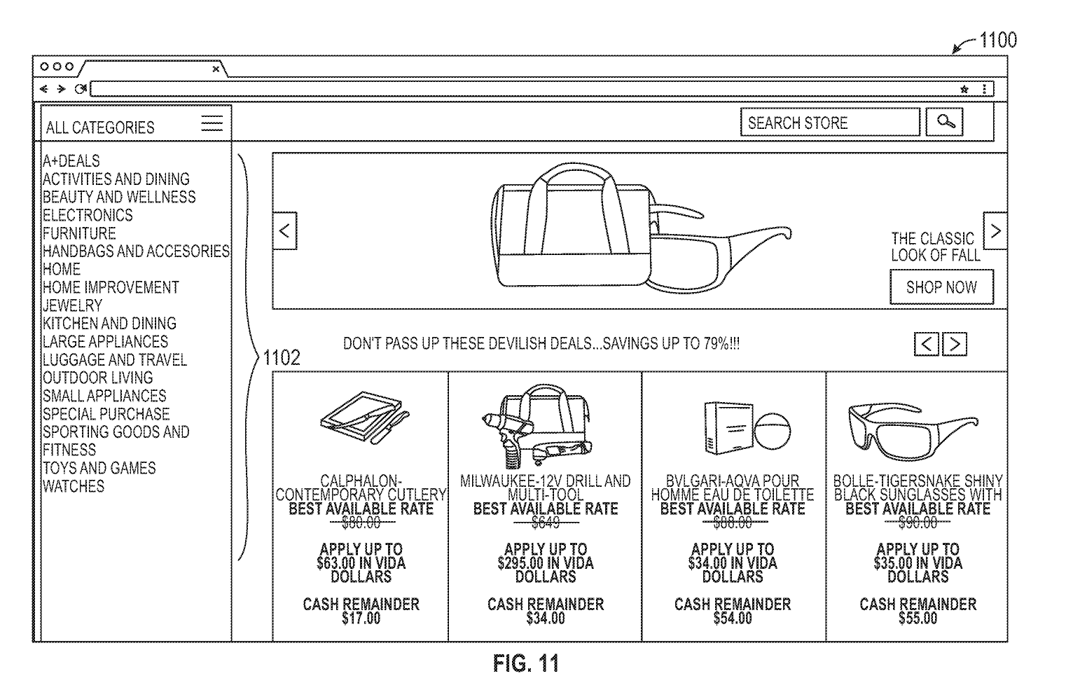

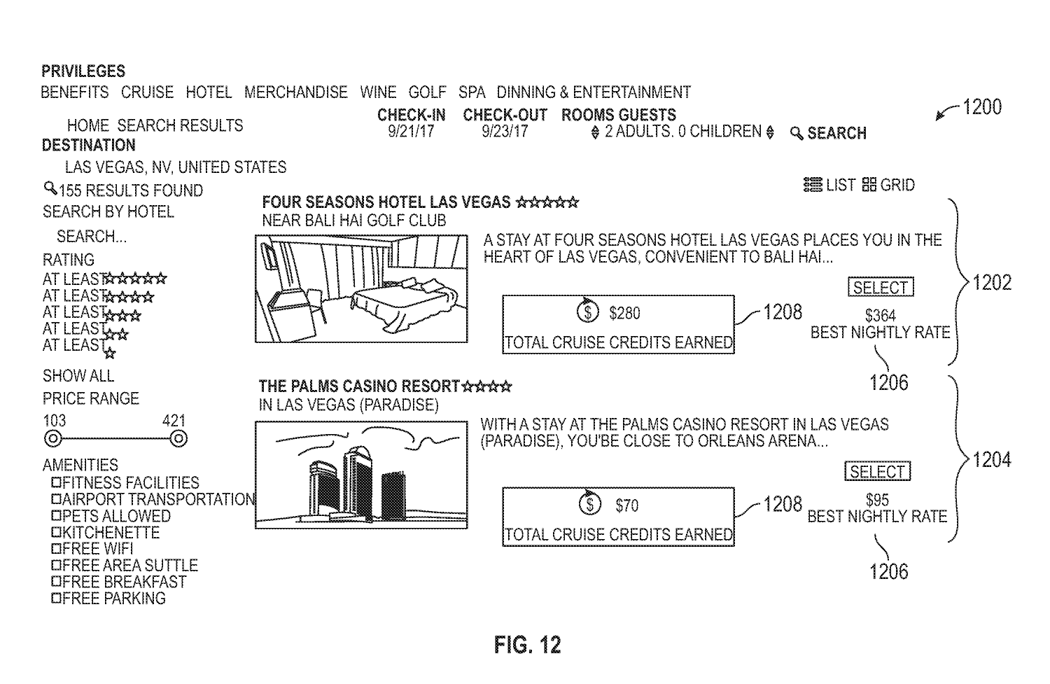

FIG. 11 is a screen shot of a landing page 1100 for an exemplary cruise rewards program, depicting any number of categories 1102 of travel related and non-travel related products, services, and merchandise. Clicking on a hotel category and searching for Las Vegas hotels for a particular date range reveals the search results shown in FIG. 12.

FIG. 12 is a screen shot showing a search results page 1200 including a plurality of available rooms 1202, 1204, each depicting the best nightly rate (generally analogous to a FMV rate) and earned cruise credits 1208. As discussed above, the earned cruise credits are generally analogous to the net margin available to the system. In the cruise rewards use case, however, a substantial portion of the available margin is used to fund the earned credits, as opposed to being used to reduce FMV to MPR as described in connection with FIG. 4.

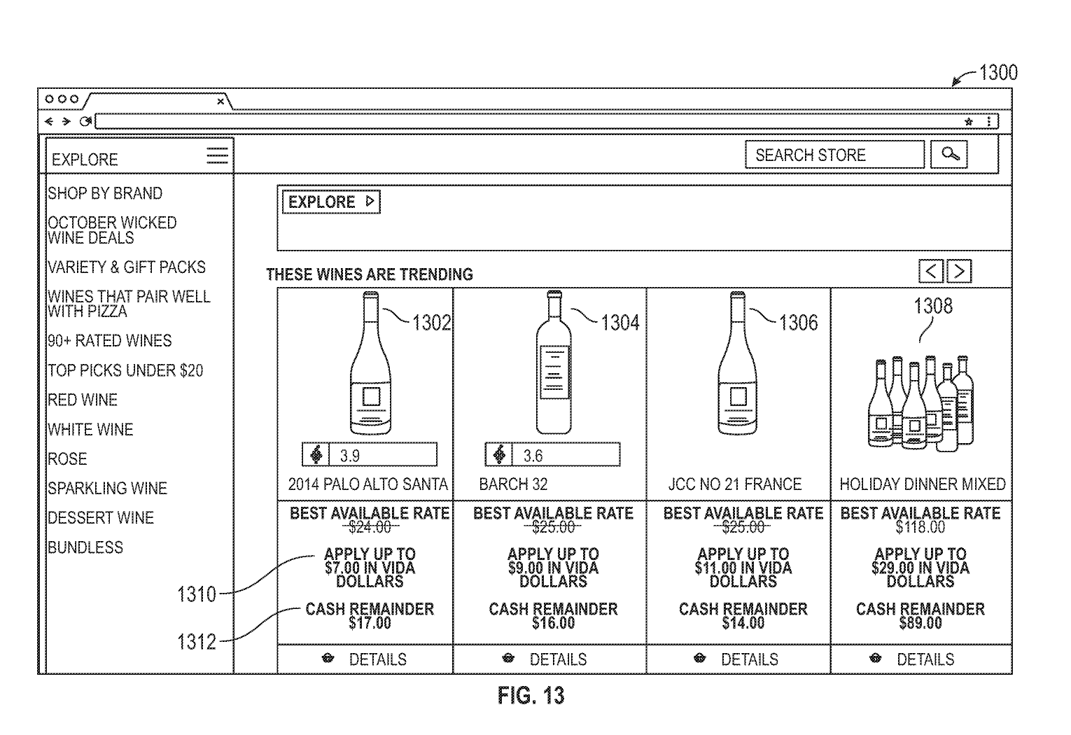

FIG. 13 is a screen shot showing an exemplary search results page 1300 within a cruise rewards platform, illustrating a plurality of product options 1302-1308 (wine in the example shown) responsive to the search query, each depicting an FMV 1310 and an earned cruise credits field 1312.

An integrated code base is provided for dynamically configuring a polymorphic user interface across multiple uniquely branded travel sites. The code base includes a user module configured to: retrieve a unique user profile, including a lifetime value, in response to receiving a credential from a user; retrieve one of a plurality of product rule sets in response to receiving a selected product category from the user; and prompt the user to define a requested product. The code base further includes a general logic module configured to: execute one of a plurality of business rule sets based on a detected brand identifier; retrieve a plurality of price points from a plurality of remote servers, respectively, using the retrieved product rule set; calculate a fair market value (FMV) for a requested product using the plurality of price points; retrieve the cost basis for the requested product from a database associated with the code base; calculate a retail price for the product based on the FMV, the cost basis, the executed business rule set, and the lifetime value; and simultaneously display on the user interface the FMV, the retail price, and a plurality of hyperlinks corresponding to a subset of the plurality of remote servers.

In an embodiment, each of the plurality of business rule sets comprises a revenue sharing rule and at least one styling rule for a graphical element do be displayed on the user interface.

In an embodiment, the product rule sets comprise a first rule set corresponding to merchandise, a second rule set corresponding to hotel rooms, and a third rule set corresponding to cruises.

In an embodiment, the retail price is greater than the cost basis and less than the FMV.

In an embodiment, the general logic module is configured to retrieve the plurality of price points in real time.

In an embodiment, the general logic module is further configured to: calculate a net margin based on the difference between the FMV and the cost basis; and transfer a portion of the net margin to the user.

In an embodiment, the net margin is transferred to the user in the form of at least one of: i) a cash back award; and ii) a credit toward future transactions.

A method of dynamically configuring a web based user interface is provided, the method including the steps of: identifying a unique lifetime value for a user; retrieving one of a plurality of product rule sets for a product category selected by the user; prompting the user to define a desired product; retrieving a plurality of price points from a plurality of remote servers, respectively, using the retrieved product rule set; calculating a fair market value (FMV) for the desired product using the plurality of price points; calculating a member preferred rate (MPR) for the product based on the FMV and the lifetime value; and displaying on the user interface the FMV, the retail price point, and a plurality of indicia corresponding to a subset of the plurality of remote servers.

A method is provided for normalizing disparate hotel rooms across independent distribution channels, the method including the steps of: creating a meta-category matrix of sameness metrics for the hotel rooms; retrieving room descriptions for a plurality of rooms from each of a plurality of distribution channels; algorithmically assigning equivalent rooms to the same meta-category based on a rule set; identifying rooms which do not correspond to a meta-category; manually assigning the identified rooms to a meta-category; and revising rule set based on the manual assignment.

In an embodiment, the further includes determining a fair market value for a meta-category of normalized rooms and displaying the FMV along with links upon which the FMV is based.

A method is also provided for normalizing disparate hotel room products across independent distribution channels, comprising the steps of: creating a meta-category matrix of sameness metrics; algorithmically assigning same rooms to various categories; identifying mismatches; manually or semi-automatically assigning mis-matches; revising rule sets; based on normalized groupings, determining an FMV; and displaying the FMV along with representative links.

A method for incenting a user to purchase a cruise is provided. The method includes the steps of: providing a shopping portal which contemplates at least the following categories: dining, hotel, and merchandise. The method further includes, for each purchase transaction completed by the user using the portal: determining a fair market value (FMV), a cost basis, and a gross margin based on the difference between the FMV and the cost basis; allocating a portion of each gross margin, based on a lifetime value associated with the user, to a savings account associated with the user; and applying the savings account to the purchase price of a cruise.

In an embodiment, the method further includes displaying a message indicating the amount allocated to the savings account in real time.

A method is provided for incenting a user to purchase a second cruise, the method including the steps of: presenting a user with a folio at the end of a first cruise, the folio representing products and services purchased during the first cruise; receiving a payment from the user for the folio amount; registering a user on a shopping portal which contemplates at least the following categories: dining; hotel; and merchandise; applying the folio amount to a savings account associated with the user on the portal; and using the savings account to pay down a portion of the gross margin associated with purchase transactions in the foregoing categories; wherein the portion of the gross margin is determined based on the fair market value (FMV) of the transaction and a lifetime value associated with the user.

A system is provided for processing a purchase transaction for a product selected by a member, the system comprising: a gross margin module configured to calculate a gross margin based on a fair market value (FMV); a net margin module configured to calculate a net margin based on the gross margin, overhead costs, and transactional expenses; a lifetime value module configured to calculate a lifetime value associated with the member; and a yield engine configured to calculate a member preferred rate (MPR) based on the net margin and the lifetime value.

In an embodiment, the system further includes a display module configured to display the MPR and a plurality links to websites supporting the veracity of the FMV.

A method is also provided for tracking a future lifetime value (FLV) parameter associated with a member of a rewards program, the method comprising the steps of: establishing an initial negative value for the member based on the member's estimated acquisition cost; detecting a non-monetary even performed by the member; assigning a first value to the non-monetary event; and updating the member's FLV to reflect both the initial negative value and the first value.

In an embodiment, the non-monetary event comprises the member opening an email received from the online rewards program.

A method is provided for calculating a gross margin associated with a purchased product, and allocating the gross margin between a consumer and a web based shopping portal. The method includes the steps of: receiving a product definition and a personal credential from the user; using the personal credential to determine a user class and a unique lifetime value associated with the user; defining a first group of retail sites and a mutually exclusive second group of retail sites; retrieving respective price quotes for the defined product from the first and second groups of retail sites; associating one of the first and second groups with the user based on the user class; calculating a fair market value (FMV) based on the price quotes retrieved from the associated group; determining a cost value of the defined product; calculating a MPR based on the FMV, the cost value, and the lifetime value; displaying the FMV, the retail price, and a subset of the associated group; and prompting the user to purchase the defined product at the retail price.

In an embodiment, calculating the retail price comprises: calculating a gross margin based on the difference between the FMV and the cost value; and allocating a portion of the gross margin to the user.

In an embodiment, allocating comprises providing at least one of: i) a cash back award; and ii) a credit toward future transactions

In an embodiment, retrieving respective price quotes comprises scraping the retail sites in real time.

In an embodiment, scraping comprises retrieving raw HTML without associated graphics files.

In an embodiment, calculating the FMV comprises identifying a statistical mode from within the associated group.

In an embodiment, calculating the FMV comprises identifying a cluster of retail sites having the same price point.

In an embodiment, calculating the FMV comprises filtering the retrieved price points based on whether the retailer is then currently selling the product at the advertised price.

In an embodiment, calculating the FMV comprises executing a weighted algorithm against the retrieved price points.

In an embodiment, the FMV is based on at least one site from each of the first and second groups.

A method is also provided for providing a real time cash incentive to a user for purchasing a hotel room using a web based portal, the method comprising: prompting the user to provide a date, a geographic location, and a credential; determining a consumer class and a lifetime value for the user based on the credential; retrieving respective price quotes from a plurality of remote web sites based on the date and geographic location; applying a weighted algorithm to the price quotes to determine a fair market value (FMV), where the weights are based on the consumer class; determining a MPR based on the FMV and the lifetime value, where the difference between the retail price and the FMV comprises a savings value; and displaying the FMV, the retail price, and indicia of the web sites upon which the FMV is based.

In an embodiment, the method further includes eliminating price quotes which do not support a predetermined value proposition.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. A method for normalizing hotel rooms across independent distribution channels, comprising:
creating a meta-category matrix of sameness metrics for the hotel rooms based on a set of attributes;
retrieving room descriptions for a plurality of the hotel rooms from a plurality of the independent distribution channels;
automatically assigning equivalent hotel rooms to the same meta-category based on a rule set applied to the retrieved room descriptions and the set of attributes;
identifying hotel rooms that do not correspond to one of the meta-categories;
manually assigning the identified hotel rooms to a meta-category; and
revising the rule set based on the manual assignment.

2. The method of claim 1, further including determining a fair market value (FMV) for a meta-category of normalized rooms and displaying the FMV with links to independent distribution channels upon which the FMV is based.

3. The method of claim 1, wherein the attributes are selected from the group consisting of smoking/non-smoking, view class, fitness center, room size, number of beds, price, kitchenette, free breakfast, in-room bar, floor level, and bed size.

4. The method of claim 1, wherein the rule set assigns the identified hotel rooms to the same meta-category if at least a predetermined number of its attributes match those of a selected meta-category.

5. The method of claim 1, wherein revising the rule set employs adaptive fuzzy-logic techniques.

6. The method of claim 1, wherein revising the rule set includes adding an attribute to the matrix of sameness metrics based on a room description.

7. A system for normalizing hotel rooms across independent distribution channels, comprising:
a general logic module configured to:
create a meta-category matrix of sameness metrics for the hotel rooms based on a set of attributes; and
retrieve room descriptions for a plurality of the hotel rooms from a plurality of the independent distribution channels;
a rules engine module configured to:
automatically assign equivalent hotel rooms to the same meta-category based on a rule set applied to the retrieved room descriptions and the set of attributes;
identify hotel rooms that do not correspond to one of the meta-categories;
manually assign the identified hotel rooms to a meta-category; and
revise the rule set based on the manual assignment.

8. The system of claim 7, further including a fair market value (FMV) module configured to determine a fair market value (FMV) for a meta-category of normalized rooms and display, on a user interface, the FMV with links to independent distribution channels upon which the FMV is based.

9. The system of claim 7, wherein the attributes are selected from the group consisting of smoking/non-smoking, view class, fitness center, room size, number of beds, price, kitchenette, free breakfast, in-room bar, floor level, and bed size.

10. The system of claim 7, wherein the rule set assigns the identified hotel rooms to the same meta-category if at least a predetermined number of its attributes match those of a selected meta-category.

11. The system of claim 7, wherein the rule set is revised utilizing an adaptive fuzzy-logic technique.

12. The system of claim 7, wherein the rule set is revised by adding an attribute to the matrix of sameness metrics based on a room description.

13. A non-transitory computer-readable medium having software instructions stored thereon that, when executed by a processing device, cause the processing device to:
create a meta-category matrix of sameness metrics for the hotel rooms based on a set of attributes;
retrieve room descriptions for a plurality of the hotel rooms from a plurality of the independent distribution channels;
automatically assign equivalent hotel rooms to the same meta-category based on a rule set applied to the retrieved room descriptions and the set of attributes;
identify hotel rooms that do not correspond to one of the meta-categories;
manually assign the identified hotel rooms to a meta-category; and
revise the rule set based on the manual assignment.

14. The non-transitory computer-readable medium of claim 13, wherein the software instructions further cause the processing device to determine a fair market value (FMV) for a meta-category of normalized rooms and displaying the FMV with links to independent distribution channels upon which the FMV is based.

15. The non-transitory computer-readable medium of claim 13, wherein the attributes are selected from the group consisting of smoking/non-smoking, view class, fitness center, room size, number of beds, price, kitchenette, free breakfast, in-room bar, floor level, and bed size.

16. The non-transitory computer-readable medium of claim 13, wherein the rule set assigns the identified hotel rooms to the same meta-category if at least a predetermined number of its attributes match those of a selected meta-category.

17. The non-transitory computer-readable medium of claim 13, wherein the software instructions cause the processing device to revise the rule set using an adaptive fuzzy-logic technique.

18. The non-transitory computer-readable medium of claim 13, wherein the software instructions further cause the processing device to revise the rule set by adding an attribute to the matrix of sameness metrics based on a room description.
